(19) United States
(12) Patent Application Publication
(10) Pub. No.: US 2006/0184560 A1
(43) Pub. Date: Aug. 17, 2006

(54) The health care system of the universal and continuously enriching medical information

(76) Inventor: Goran Indjic, Mississauga (CA)

Correspondence Address: GORAN INDJIC, 55 PARK STREET EAST, #1406, MISSISSAUGA, ON, L5G-1L9, CA

(21) Appl. No.: 10/906,358

(22) Filed: Feb. 15, 2005

(51) Int. Cl. G06F 17/00

(52) U.S. Cl. 707/102

(57) ABSTRACT

Doctors input the clinical information of patients into their universal clinical-laboratory forms of the computer network system of the organization, take the different specimens and submit these records in the system that gives them the numbers that they write on the specimen containers and the kits. These numbers are also given to the examined patients if they need to go to the different health providers. Doctors order the microbiological kits and the specimen containers by the ordering computer forms of the same system. The health providers open the specific universal clinical records by the specific numbers of the containers, the kits and patients, provide service and input information of their service in specific designated places of the universal clinical-laboratory forms. They submit this information to the referring doctors who treat patients according to them or start a new examination by the new universal clinical forms. The system continuously analyzes information of all the clinical records and provides statistical data concerning present diseases, their locations, the different causes including different organisms, the sensitivity patterns of the isolated pathogen bacteria and another health related data. This analyzed information is continuously available in the Watchdog. The same system also enables the authorized health providers to interact with the system in the Watchdog in order to improve their service, treatments of their patients and the system. The system also allows that the patients get their complete medical data that copied from the system. They are printed out as their personal paper records. Patients collect and fulfill specific information concerning their health into the specially designated places of the paper records, previously compiled by their doctors. The same patients will give this information to their doctors who will incorporate them in the information of the universal clinical-laboratory records.

The invention is based on the website residing on a server that collects the specific information that is sent from the different health providers and patients by their computers over the Internet. The server also groups, analyzes and sends the enriched information back to the different users.

The most important objectives of this invention are reluctance of physicians to accept medical informatics and prevention of diseases despite the known facts that are logical solutions of many medical problems. Other objectives are simple, efficient, qualitative and affordable health care system that will easily communicate with the different health systems, the insurance companies and the existing political system. The physicians will only accept medical informatics (computers in medicine) easily if:

1. Computers do not change extremely old systems of their work. Therefore, the universal clinical-laboratory forms of the computer system allow them to do the same work that they are used to.

2. The computer system is very simple and it can be learned quickly. Many physicians already know basics of computer use such as: connecting to the Internet and finding websites. The system will enable them to make appointments for their patients to the satisfaction on all subjects.

3. Physicians are not saturated with unnecessary information. They want to deal with simple information that allows them to develop their creativities. Therefore, the system is very conservative concerning “extra” information in comparison with the other systems in order to be very progressive.

4. Functions of computers are reduced maximally. Books are still a good source of information.

5. The information that is a product of the system is very simple and basic. This is also provided in the Watchdog of the system.

6. Their personal creativities can change their service and the system. They interact with the system in the Watchdog where they can also follow their impact on the service and the system.

Sick people find the website on the Internet using their personal computers where they find the appointment charts of the different health providers with their names that are entered in the alphabetical orders. They find the appointment charts of their family (primary care) physicians where they input their names according to their available time and then submit. After submission they cannot change the appointment time due to protection of the system. They go to visit their physicians according to the appointment time arranged this way.

The patients bring with themselves their personal health paper records. When the patients get in, they show to their physicians their health cards and their health paper records.

The physicians open the patient files in their computers, where they find their medical records by their names and the record numbers. They open their new universal clinical-laboratory forms here as well. The system also gives the summarized clinical diagnosis, treatments and laboratory results with dates also by the website program that the physicians can get general health pictures of their patients.

The patient health paper records have the medical information concerning patient's health fulfilled by the patients according to questions and instructions of their physicians previously arranged by them. The physicians read the records and ask patients of their health problems. The physicians input the new clinical histories according to this data and perform clinical examinations and summarize everything in the present clinical diagnosis. The system gives different clinical diagnosis in alphabetical order. The physicians find the clinical diagnoses that are compatible with their conclusions and then click.

The physicians take the specimens if further examinations are necessary. They have the different specimen containers, the microbiological kits, syringes and other materials for taking of the specimens in their offices. The microbiological kits are designed according to the specimens and their most common pathogen organisms (bacteria, viruses, parasites, yeasts and fungi) that cause infectious diseases. The following kits are designed: the sputum kit, the bronchoscope kit, the CSF kit, the pus kit, the urine kit, the sexual transmitted diseases kit and others. The kits have different media that provide growth of the different pathogen organisms, including swabs, microscopy slides, gloves and other material for a safe taking of the specimens.

The physicians take the specimens, put them in the containers and inoculate them in the media of the microbiological kits. They enter this information to the universal clinical-laboratory records. The physicians proscribe treatments and make the questionnaire according to the specific health problems of their patients or refer the patients to other health providers. The physicians also make new appointments for the same patients in their appointment charts. When their services are finished, they input the prices of their services, including prices of the kits and containers that are used for their patients, their personal ID (identification) numbers and submit the forms in the system. The system gives the submission numbers to those forms that are composed of the present time and date of the submission and they serve as identification numbers of the universal clinical-laboratory records. The physicians write the submission numbers on the containers with specimens and on the kits with inoculated media. After submission, the physicians cannot change any more information in their clinical-laboratory records again due to protection of the system.

The physicians give the submission numbers to the patients if they need to go to the other health providers who can get in the system by their ID numbers.

The patients go to the pharmacists without any proscription and bring only the above submission numbers. The pharmacists open their universal clinical-laboratory records by them where they can find proscribed drugs. They give the drugs to the patients, input their service prices, prices of drugs and their IDs in the universal clinical-laboratory records and submit. Pharmacists are also medically educated and with this practice they can also be actively involved in treating patients with their advices. This will also give them opportunities to learn actively.

The patients go to the specialists also with the submission numbers according to the previous arranged appointment time by their family physicians. The specialists open their universal clinical-laboratory records where they find all the necessary information, write the information of their services, including their service prices and their personal ID numbers in the extension forms of the same universal clinical-laboratory forms and submit. The system also gives present time and date of their submissions. If the patients need the extensive investigations then the same specialists open the new clinical-laboratory forms as the primary care physicians and work the same as the family physicians. If the patients go to the hospitals, then the hospitals physicians also open the new clinical-laboratory forms and work the same as the family (primary care) physicians.

The physicians use the ordering forms of the same system to order the microbiological kits and the specimen containers. The transport providers and the kit producers open the ordering records where they can find which kits and containers are needed and where they should be transported. The ordering forms also have information of the containers with the specimens and the inoculated kits that are transferred from the submitted universal records by the website program in order that the used kits and containers can be transferred from the clinics to the laboratories.

The kit producers produce the specific kits and prepare containers for the transport providers according to the above information. Before they give them to the transport providers, they put the price of their containers and kits together with their ID numbers and the ID numbers of the transport providers in the ordering records and then submit. The transport providers take the containers and kits and transport them to the physicians. They take the inoculated kits and containers with the specimens from the physicians and transport them to the laboratories.

They give them to the laboratories, input their information of the transport (spent time, spent kilometers and the transport prices together with their ID numbers) in the ordering records and submit them in the system.

The laboratory technologists take the containers and kits with specimens, open the website, get in the system by their personal ID numbers as any authorized member of the system and input the numbers of the containers and the kits. The system opens the universal clinical-laboratory records where they can find what should be done. The system enables them to see the complete medical problems of their patients and to focus on their investigations. After completion of the work they input their results, the service price together with their ID numbers in the extension forms of the universal clinical-laboratory records and submit. The information submitted into the system cannot be changed due to protection of the system. This will also be a way of their active learning and the most important consequence of this is the quality and efficiency of the service.

The patients come back to their referring physicians who open their universal clinical-laboratory records enriched with information of the different health care providers. They work according to this new information. They open the new clinical-laboratory records and work as in the previous ones and submit. When they open the new clinical forms, the old universal clinical-laboratory records are completed. They print the copies of the information in the patient paper records. The patients will answer the questionnaires that are designed according to their specific health problems. The fulfilled information according to the questionnaires will get in the patient clinical histories in their next examinations. Therefore, the above-described system is called the health care system of the universal and continuously enriching medical information.

The universal clinical-laboratory and the ordering records bring different information that are continuously analyzed and summarized in the Watchdog of the system. The information of the present diseases with their causes and treatments, the causative pathogen organisms (viruses, bacteria, fungi, yeasts and parasites) of the specific infectious diseases, the sensitivity patterns of the isolated pathogen bacteria, prices of treatments are also summarized and given in percentages according to locations where patients live. This universal information of the Watchdog is prepared for the different health providers who use them. The health providers interact with this information in the same Watchdog in order to improve their service and the system.

The information of the universal clinical-laboratory and the ordering records are grouped by the website program according to the involved patients and the providers of the system by the following groups:

The medical records of the patients

The work records of the different providers

The work records of their institutions

The records of the Watchdog

The medical files of the patients have their personal universal clinical-laboratory records. Some of their information (different laboratory results with dates, clinical diagnosis and proscribed treatments with dates) is summarized by the website program so that the physicians can quickly get in the stream of the existing medical problems when they open the new universal clinical-laboratory forms. The patients also get the summarized bills after the service is completed or the bills are automatically transferred to their insurances. The patients or the insurance companies pay the bill to the organization account by the authorized banks. The system gives information of the earned money of the involved health providers to the bank so that it can transfer the money from the organization account to the accounts of the health providers. The work records of the health providers have the universal clinical-laboratory records of those patients who were involved in their service. The website program also summarizes their clinical diagnosis, the proscribed treatments, their service, and the service prices with dates for their personal needs. The work records of the health providers have also summarized some information of the ordering forms also by the website program. The information of the ordered different kits and different containers together with their prices and the service prices of their transport are summarized by the website program in the order that the website program can calculate the prices of the specific kits and containers that will be given to the patients by their physicians. They charge their patients for them together with their service. The work records of the kit producers collect information of the ordered kits and containers, including their prices also by the website program. This information is needed so that they can plan their production and for their personal needs. The work records of the transport providers collect information concerning transport of the specimens, including transport prices to be able to organize their deliveries and also for their personal needs. The work records of the institutions have the universal clinical-laboratory forms of those patients who visited them. The website program also summarizes their clinical diagnosis, the proscribed treatments, their service, service prices with dates for the personal needs of the health providers who work in these institutions. This information will help them organize their work and be more efficient. The records of the Watchdog have all the information of all the universal clinical-laboratory and ordering records. The above data are summarized historically for a specific period of time in the order that can be compared with the present ones.

The health providers and other providers are members of the organization who follow the specific rules that enable the above-described system. They must be authorized by the organization to get in the system.

In summary, anticipation of the diseases of different patients can be done only if all subjects of the system are actively and constructively involved. They can be actively and constructively involved only if they get money and satisfaction for their work. The above invention is compared with the existing system in order for the values to be understood.

A sick man, woman or child comes to a doctor to look for medical help. They wait sometimes three to five hours and get in the office without any written medical information, except that they sometimes bring some information from other doctors. Their medical information is in the office of their family doctors who protect their information from people and themselves due to many known (confidentiality) and unknown reasons. Opposite of this, doctors propagate that prevention of diseases is the future of a healthy man and that people can prevent disease only if they know more about them. This contradiction is the fact.

Family doctors put their medical information in forms of the medical paper charts given by nurses or they store them in their local computer systems. Family doctors usually put down only major medical problems in their charts with their “beautiful” handwriting because “family doctors know everything about their patients”. It is most likely the reason why they call them family doctors. Of course, they cannot remember many things about hundreds of patients. The author knows about this from personal experiences. Patients usually need other examinations by other health providers to enrich their medical information and to do this; doctors must fill out different requisition forms. This is very boring and time consuming but necessary and contemporary job. Despite the above information, patients go with poor medical information to enrich them.

Communications between clinics and laboratories are also very poor and that is a fact. Doctors think that laboratory workers always know what to look for in the specimens due to a lack of knowledge of technology of their processing. Opposite, the laboratory workers do not know what to look for in them due to a lack of proper information (clinical diagnosis) and poor understanding of pathological processes.

The referring doctors get the information in the written form from the different health providers, including different laboratories by post, fax or email. This information is put in their medical chart or in their computers. This information should be put in their charts by historical order and summarized. This job is usually not done due to many known and unknown reasons. One of them is a big number of patients and confusion of family doctors. This is an explanation why the proper information does not exist and a powerful instrument that can anticipate future diseases. Patients also go to hospitals with poor histories. Hospitals also do not give rich information to referring doctors of their patients, again due to many reasons. If patients change family doctors than, confusion is complete.

There are many patented systems and methods that improve the existing health systems in different ways and only the systems and methods most related to the claimed system will be mentioned and discussed in order to better understand the problems that are solved by the invention:

Kempster (U.S. Pat. No. 3,960,634, 1976) found that adding of small amounts of information by adhesive sheets to an existing record simplify the process of collection and analyzing of medical information. Sonsteby (U.S. Pat. No. 4,865,549, 1989) added structure to the documentation process by color-coded adhesive labels to organize the document and eliminate omissions of crucial data elements. These old ideas are still progressive for today's health system. The physician needs small amount information clearly labeled that can easer focus on the medical problems and analyze them.

The U.S. Pat. No. 4,878,175 (1989) “Method for generating patient-specific flow sheets by adding/deleting parameters” is similar to the above claimed invention in that, that “patient information is entered into the system via the terminals”, but it is different in that, that it “is organized hierarchically in the system, and may be displayed to users having proper access to the system.” In the same invention “once a patient is selected from a census list, all further access to information concerning such patient is obtained in a two-level selection process by (1) selecting a descriptor corresponding to information at a first organizational level, and (2) selecting a descriptor corresponding to information at a second organization level. Various parameters can be added to or deleted from the information at the second organizational level on a patient-specific basis by an authorized system user. Certain parameters may be “pre-printed”, and other parameters may represent “macro” parameters.” The system of the U.S. Pat. No. 4,878,175 is much more complicated than the above claimed system:

1. A patient is selected from a census list; all further access to information concerning a patient is obtained in a two-level selection process. The claimed system has only the universal clinical-laboratory information that is submitted and the number that gets access to the specific universal clinical-laboratory information.

2. The results are transmitted from the laboratory in a data stream formatted for cumulative result reporting.

The claimed system has the universal clinical information that is enriched with the laboratory results.

The claimed system is in an essence different in a comparison with the above-patented system. The claimed system is better because enriched information is in accordance or discordance with the clinical start diagnosis and by this, confirms it or changes it in the new universal form.

The U.S. Pat. No. 5,077,666 (1991) “Patient information is entered into the system via the terminals, is organized hierarchically in the system, and may be displayed to users having proper access to the system. The system provides a time-oriented task list, which is automatically generated from data that has been entered from physicians' and nursing orders. Tasks may be charted by a system user without exiting from the task list, and all associated form(s) are automatically updated.”

The invention (U.S. Pat. No. 5,077,666) has two methods:

“According to a first method, described and claimed herein, the system user may chart the completion of a task without leaving the context of the task list by opening a window into the appropriate underlying form and charting the task directly onto such form. When the system user signs the completion of the task, the task list and any associated form(s) are automatically updated at the same time as the task completion is recorded on the underlying form.”

“According to a second method, described and claimed in Related Invention No. 3 identified above, the system user may chart the completion of a task directly onto an appropriate system form, and when the system user signs the completion of the task on such form, the task list and any associated form(s) are automatically updated at the same time as the task completion is recorded on such system form.”

The claimed system has only a universal clinical-laboratory form and a method where all health providers are actively involved.

The U.S. Pat. No. 5,301,105 (1994) is invention of “a fully integrated and comprehensive health care system that includes the integrated interconnection and interaction of the patient, health care provider, bank or other financial institution, insurance company, utilization reviewer and employer so as to include within a single system each of the essential participants to provide patients with complete and comprehensive pre-treatment, treatment and post-treatment health care and predetermined financial support there for.”

The health care system of a universal and continuously enriching medical information also integrate all the subjects involved in the health care giving system, as health providers, bank or other financial institution by the universal clinical-laboratory and the ordering records that bring the prices of the provided services although this is not the main objective. The billing system is very important because it is fuel of any system, including this one claimed.

The U.S. Pat. No. 5,508,912 (1996) is the model of “‘audit trail’ system, its data pool, file relationships and programs that process the data to load, manipulate, print and query the clinical data along with its method of triaged data processing by out-patient diagnostic categories” that follows logistics of existing forms and systems. It has some elements of the Watchdog: “For example, detecting the overuse of office visits by out-patients pre-selected by diagnostic category, monitoring the actions by physicians during protracted episodes of out-patient illnesses, and the separate reporting of physical, medication and lab test results from the same office visits selected by the primary reason, acute or chronic diagnosis, for the office visit.” The Watchdog of the above claimed system deals with other problems, although can analyze the same problems.

The U.S. Pat. No. 5,590,648 (1997) is invention of “a personal health care system utilizing a unitary command center having a computer for receiving, storing, processing, and transmitting information, and a plurality of interfacing ports. Each interfacing port is adapted to accept a plurality of different patient monitoring sensor modules, a plurality of different accessory modules, and a plurality of different therapy-providing modules.” The invention (U.S. Pat. No. 5,590,648) is related to the below Canadian invention.

The CA Patent 2,309,052 (1998) is invention where “a centralized host computer maintains, consolidates, and redistributes information generated at all networked locations. Information is electronically transferred among the system components to link an individual's local records to those stored remotely. The individual information device, centralized host computer, and any other computers or networks linked to the system can therefore be automatically updated. An individual information device stores a service recipient's insurance information, an emergency records and critical health care histories. This information is accessed by the system for use in managing any aspect of the service recipient's health care.”

The health care system of a universal and continuously enriching medical information invention is also website based with a server that collects the specific information that are sent by the computers from the different health providers and patients, analyzes them for the watch dog and distributes them for the different users. The claimed invention differentiates in essence from the above inventions in that that collects the different specific information for the specific needs of the specific users. The CA Patent 2,309,052 invention collects the specific information as any of an individual service recipient's insurance information, emergency records, health care history, diagnostic and treatment support, service payment management, accounting services, maintaining service provider records, including licensing information, staffing affiliations, organizational ownership information, tax identification information, curriculum vitae of licensed practitioners, information regarding disciplinary actions and so on. Unnecessary information only reduces efficiency of the system. The health care system of a universal and continuously enriching medical information invention collects the specific information organized in the universal clinical-laboratory and the ordering computer forms that are further analyzed according to specific needs of the different health care providers.

The U.S. Pat. No. 5,590,648 collects the specific information “selected from the group consisting of a breathing rate sensor module, a pulse rate sensor module, a body temperature sensor module, a blood pressure sensor module, a urinary discharge volume sensor module, an oximeter sensor module, an ECG sensor module, an EKG sensor module, an EEG sensor module, an oxygen analyzer module, a fetal monitor module, a dental patient monitoring module, and a multi-gas analyzing module.”

The U.S. Pat. No. 6,000,828 (1999) Method of improving drug treatment is also “A computer implemented method and system for improving drug treatment of patients in local communities by providing drug treatment protocols for particular disease states, such as Diagnosis Related Group (DRG) classifications. The protocol contains ranked recommendations for drug treatments of the disease state, and the computer system collects information about the risks and benefits of the drug treatments. The information collected about the treatments is used to modify the rankings of the drug treatments in the protocol. In one specific embodiment of the system, where the disease state has a microbial etiology and the treatments are antimicrobial drugs, the emergence of drug resistance is quickly detected by determining the percentage of microbial isolates that are found to be resistant to antimicrobial therapy in the community where the therapy is being provided (such as a community hospital or city-wide health care system). An increase in the percentage of resistant isolates produces a re-ranking of recommended drug therapies to avoid further use of the drug to which resistance has developed, and helps quickly introduce more effective drugs that will improve the effectiveness and lower the cost of treatment.” This invention is related in some points with the content of the Watchdog of the claimed system. It helps to be proscribed treatment according to the protocol. The claimed system can also collect information about the risks and benefits of the drug treatment although this is not mentioned. The health care system of a universal and continuously enriching medical information does not have the protocols and recommended treatments but instead of this has an instrument of the watch dog that continuously observes different diseases and their treatment. The claimed system does not give any recommendation and this matter is thoroughly left physicians to decide. The treatment must be proscribed specifically for any patient and his/her diseases according to the claimed system.

The U.S. Pat. No. 6,018,713 (2000) “Integrated system and method for ordering and cumulative results reporting of medical tests” is also “a network-based system and method for ordering and cumulative results reporting of medical tests.” It “includes a computer operated at a physician location (such as a hospital or physician office) to order tests, retrieve and store statistical data or status the progress of previously ordered tests, and at least one lab site computer for receiving physician requests for tests and reporting their results. The physician computer and lab site computer are interconnected by a computer network.” The physician from the U.S. Pat. No. 6,018,713 does not input the specifically arranged clinical information (clinical history, clinical diagnosis, recommended treatment, referring to other health providers and new appointments) in the system that will be seen, analyzed and enriched with the results of other health providers. The physician only requests tests and receives laboratory results, retrieves and store statistical data or status the progress of previously ordered tests. They explain further that “The physician computer receives a physician or user request for ordering a test, causes a test request message to be sent to the labsite computer, causes a request for statistical data to be sent to the network, and receives statistical data from the network. The lab site computer is programmed to receive a test request message and to cause a test results message or a test status message to be sent to the physician computer.” The essential difference is that their system does not solve essential problems of chaotic information and moreover it generates a new chaos. The same authors answered by their invention why “One barrier to implementation of these networks has been resistance by practicing physicians.” Many physicians are computer-phobic with reasons and resistant to change in their practice methods. The same authors accept that “There is an industry-wide consensus that physicians will routinely use hospital and office computers only when they become easy to use and when they provide significant applications that save time, improve productivity, and streamline the patient care process.” This is the main objective of the health care system of the universal and continuously enriching medical information. “Another barrier to effective operation of such community health networks has been an inability to electronically transfer patient test records between a variety of geographically dispersed offices and display them in an effective standardized format. Many smaller clinical laboratories still mail office test results to doctors. The larger labs deliver results of individual tests by courier, fax, or using an on-site printer. Relying on paper, fax and phones for reporting this information significantly reduces productivity and increases costs throughout the health care field. No U.S. hospital or freestanding clinical lab yet reports results of the billions of biochemical and microbiology tests to doctors in a standardized and integrated format.” This beautiful analysis by the same authors is also an opinion of the author of the above claimed invention. In the author's opinion, their system solves the problems of transferring information but not the essential problems of chaotic information, including the patent what they quote: “U.S. Pat. No. 4,315,309 (1982) to Robert Coli, M.D. discloses an integrated medical test data storage and retrieval system for use in a single facility such as a hospital, as shown in FIG. 1. Test request 2 is generated by a physician or other medical personnel and entered into the system through test request entry terminals 4 placed throughout the hospital. The test request is forwarded to test request compiler 6 for storage in a test request file 8, which periodically generates specimen pickup lists 10 which are distributed to wards in the hospital. Body fluids or tissue samples are forwarded to laboratory 12 in individual specimen containers 14. The tests are performed in laboratory 12 in accordance with a work profile generated on profile sheets 16. The results are recorded and entered at entry terminal 18, and forwarded to patient result compiler 20 for storage in a patient result file 22. Compiler 20 generates a ward report 24 listing tests in progress for that ward, and a diagnostic data system patient lab report 26 which is formatted to provide cumulative results reporting. With this reporting format, the test results are presented by assigning a vertical column of the page or display screen to each test, and a horizontal row to each date and time that tests were performed. In this manner, the information for each patient is presented concisely and in a manner that facilitates effective problem diagnosis. However, as can be seen, this early system was designed to operate within a single large hospital facility, and does not provide any ability to place test orders or receive test data over a network. For example, the disclosed system does not connect a doctor's office to an outpatient laboratory or clinic where patients may be sent for lab work, and does not facilitate selection of a particular laboratory from those that may be capable of performing a specific test.” The author of claimed invention agrees with some points of their analysis and that they improved and spread his system wider. No doubt, their invention is progress in a comparison with the quoted inventions below:

“Other clinical data processing systems are provided in U.S. Pat. No. 3,872,448 to Mitchell, Jr., U.S. Pat. No. 5,099,424 to Schneiderman, U.S. Pat. No. 5,262,943 to Thibado et al., U.S. Pat. No. 5,551,022 to Tariq et al., U.S. Pat. No. 5,265,010 to Evans-Paganelli et al., U.S. Pat. No. 5,262,944 to Weisner et al., U.S. Pat. No. 5,072,383 to Brimm et al., U.S. Pat. No. 5,392,209 to Eason et al., U.S. Pat. No. 5,327,341 to Whalen et al., U.S. Pat. No. 5,549,117 to Tacklind et al., U.S. Pat. No. 5,277,188 to Selker, and U.S. Pat. No. 5,546,580 to Seliger et al. However, arrangements of the types disclosed in these references similarly fail to provide medical practitioners with an optimal networked test ordering and results reporting system.” They integrate electronic test selection and result reporting: “Thus, there is a need for an improved networked computer system that provides integrated electronic test selection and results reporting, with the tests organized in a consistent and easy-to-understand manner for both selection of the tests to be performed, and reporting of the results. There is also a need for a system that provides effective communication of test orders and results between a physician's office and a remote laboratory. Moreover, there is a need for a system of this type that will identify for the physician the local laboratories capable of performing a specific test, and permit selection among those laboratories and appropriate transmission of the test order, preferably over the Internet.” In the author's opinion, their system is also very complicated, despite that they improved some segments of the existing system and that they have the objective that is different in comparison with the objectives of the health system of the universal and continuously enriching information: “Therefore, it is a general objective of the present invention to provide an improved networked computer system for integrated electronic test selection and results reporting.”

They write that their invention provides only an improved network computer system for integrated test selection and result reporting, adding that:

“Another objective of the present invention is to provide a test ordering module that organizes tests in meaningful clinical groupings (e.g. 5 groups such as basic hematology, urinalysis, basic chemistry, special chemistry, and microbiology).”

This is a good improvement but despite of this, they do not remove obstacles of the system because they do not understand processes of making of correct diagnosis and therefore they hide confusions: “A further objective of the invention is to provide a clinical test ordering and results reporting system wherein other layers of data may be attached to the test result output. For example, by clicking on a test, the user may retrieve a clinical description of the test or demographic information.” They complicate a clinical test ordering and result reporting system with other layers of data and with: “Another objective of the invention is to provide a clinical test ordering and results reporting system wherein drug advertising is inserted in the output, with a particular displayed ad triggered by abnormal clinical results.” They further complicate a clinical test and results reporting system: “It is also an objective of the invention to provide a clinical test results reporting system in which a physician workstation performs record merging by connecting to various labs and hospitals in sequence to obtain updated information and create a complete patient record.” They complicate further with: “Another significant objective of the invention is to provide a test ordering system that determines which labs perform the desired test, selects that lab's name, checks for HMO or insurance authorization, and directs the patient. The system preferably provides access to various labs.” They also complicate further: “It is also an object of the invention to provide a test ordering and results reporting system that permits patient record exchange between physicians for referrals, second opinions, etc. A central data repository may be provided to permit exchange between mini-labs. Another objective of the invention is to provide a system that provides data and demographic information such as live public health statistics through a single query across multiple hospitals. These objectives and many others which will be apparent on review of the specification, drawings, and claims are achieved in the present invention by linking each physician's office to a plurality of remotely located laboratories, and providing communication of test orders and results with each lab. The available tests are organized in meaningful clinical groupings that are consistent for both selection of the tests to be performed, and reporting of the results.” These objectives and many others of the system will produce justified resistance by practicing physicians.

Clinical Referral Process in the Brigham & Women's Physician Hospital Organizations overcame these problems in some points. It was a group of over 700 primary care and specialist physicians in the Greater Boston area who agreed together and assumed financial risk for a portion of their patients. Their referral process consisted of:

1. Entering “specific information describing the patient and any tests or procedures that are authorized’ (this is related to the universal clinical-laboratory form where the primary care physician does not need to enter the specific information).

2. Identifying “an appropriate specialist based on the patient's medical problem and any other extenuating circumstances” (the claimed system solves this by the appointment charts).

3. Checking “information entered against predefined financial and medical management criteria to determine whether the referral can be automatically approved” (the aim of the system is to produce an available and quality system for all).

4. Sending “all relevant clinical and financial information to the specialist.”

5. Sending “a report of the result of the patient's visit back to the referring physician.”

Some elements of the universal clinical-laboratory information were born here but not clearly defined and connected together. What was also not defined is the method of referring of their patient and their specimens, including their information on easy and simple ways.

The invention WO 07/069,573 is also a computer-based system which constructs medical histories by direct interactions between the patient and system where “the facts of the patient's life long and family medical history are analyzed automatically by databases to generate a set of the most reasonable diagnostic possibilities (the differential diagnosis) for each medical problem identified and for each risk factor for disease that is uncovered in the historical database. Further, the automatically analyzed database of historical medical information is used as the search tool for bringing to bear, on the diagnosis and treatment of each medical problem identified in each patient, the entirety of medical knowledge that relates to and can be useful for the correct and efficient diagnosis and treatment of each of everypatient's medical problems. This collection of information is analyzed to generate a final diagnosis and treatment regimen. “The health care system of the universal and continuously enriching medical information extracts all medical diagnosis and laboratory results with dates in a new universal clinical-laboratory form from a personal medical record but does not generate a set of the most reasonable diagnostic possibilities. Medical information is logically put that the doctor can easily analyze it in order to produce a correct diagnosis and treatment.

The invention CA Patent 2,387,236(2002) has some related points with the claimed invention, that also uses the Internet for communication amongst health providers who transfer only information concerning their examined patients and their diseases and interact with the system by the watch dog that produces only data concerning their patients and their diseases. The invention CA Patent 2,387,236 “provides a method, system, and computer program device for a medical information portal, providing a key to medical content on the Internet.” They claim further: “The invention may include one or more of the following sets of tools, in which various resources are organized in a manner which is intuitive for a healthcare professional: diagnostic tools for research of diseases, learning tools for professional development, patient tools for patient resources, technology tools on using health technology, news and updates tools, quick-reference tools, and/or electronic assistant tool. According to and aspect to the present invention, healthcare resources may be accessed via the Internet. Optionally, the system includes user registration data for each user, and certain resources may be restricted to appropriate users. The system advantageously provides, utilizing the sets of tools, a unified and organized access to a wide variety of a large number of resources that would otherwise be too confusing and/or unwieldy to access, especially in its entirety” The health care system of a universal and continuously enriching medical information does not use their source of information and similar sources in order to keep system simple. The health providers can use their information separately without interfering with the claimed system.

The invention WO 2002/052483 deals with the system and method for integration of health care records and with an integrated electronic health care information system. The health care delivery information and the health care delivery management information are stored “within the UPR as patient records, with one patient recordper patient. The information may be stored as formatted data, links to formatted data, or as selections from a list. In one embodiment, audit functionality is provided, where contact with data records is recorded as an audit trail. In another embodiment, security functionality is provided, controlling access to the integrated health care record. In another embodiment, a lock manager is provided, controlling write access to the integrated health care record.” The health care system of the universal and continuously enriching medical information has information stored in the universal clinical-laboratory records that are grouped in the patients, the health providers, the clinics and the watchdog records according to involved patients, health providers, the clinics and the watch dog. The lock manager does not exist in it. The universal clinical-laboratory forms are transferred, analyzed and grouped by their specific numbers and ID number of the involved health providers.

The invention WO 03/085577 deals also with a method and system for providing health information. The system includes “a system server and a doctor's computer system in which the system server receives patient information from the doctor's computer system, accesses in a system database a patient database record associated with a patient, updates the patient database record with the patient information to produce an updated patient database record, determines targeted information based upon contents of the updated patient database record, and transmits the targeted information to at least the doctor's computer system where the targeted information is then distributed to the patient. The system server, in updating the patient database record, may connect to at least one third party database upon a determination that the updated patient database record is not complete, access third-party information in at least one third-party database, and assimilate the third-party information into the updated patient database record. The system enables confidentiality to be maintained while providing authorized health care provider access to more complete patient information.”

The health care system of the universal and continuously enriching medical information has also a server that communicates with computers of the different health providers. The server receives the specific universal clinical-laboratory information that is continuously enriched by different health providers by the specific method and continuously analyzes and groups them according to involved patients, health providers and clinics.

The U.S. Pat. No. 6,587,072(2003) Automated laboratory software architecture invention enables an integrated clinical-laboratory software system for testing a specimen. The invention does not deal with the clinical information despite that health system provides them with the specimens and the request forms: “The work flow automation programming includes request processing programming for processing a user request for any of the tests which are available to be performed by the specimen processing modules, and also includes functional control programming which provides functional control of any of the plurality of specimen processing modules for performing any of the tests, and which further includes result data management programming provides processing of test result data of any of the tests.”

The author of the health care system of the universal and continuously enriching medical information thinks that many medical problems start with the medical record as Laxmi Chekuri & Frederick Schumacher who wrote in the article Health Systems: Improving with Information Technology that “The key for systems integration lies in the medical record. Despite the obvious need for a new record-keeping paradigm, most organizations have found it challenging to try to move to a paperless world. Companies offer medical-record software packages, but they are limited in their capabilities and seldom seem to meet the full range of needs defined within an organization. The record system must make it easy to access and display needed data, to analyze them, and to share them among colleagues and with secondary users of the record. The computer-based medical record is best viewed not as an object, or a product, but rather as a set of processes that an organization must put into place, supported by technology. The purpose is not to automate existing processes but to enable new functionality.” These above quoted problems are solved on simple way without complicated software and methods by the health care system of a universal and continuously enriching medical information. The same authors put the problem in focus despite that they do not know how to solve this problem: “To summarize, an electronic record system involves integration of large information systems. Implementation of a large-scale information system is still in its infancy but a possible reality. Organizations are experimenting with partial implementation such as decision support systems. Innovation to improve single process in medicine is less technically demanding and capital intensive. Small changes are easily accepted. Success of some organizations such as Kaiser in integrating new systems proves the feasibility and utility of such systems, providing an example to other organizations.” The same authors mentioned a good example of: “The digital revolution at Kaiser was embarked in 1998. The Net system has been in place for Northwest for two years. Only three of Kaiser's six regional divisions are using Net systems so far. When a patient comes in for a visit, doctors can instantly access their records from a keyboard and a flat-panel screen in an examination room.” The referring doctor (primary care physician) or the patients of the health care system of the universal and continuously enriching medical information can authorize the different doctors from different systems to get the complete patient information.

The authors Jeffrey S. Robinson and Deborah A. Turnbull in the article Changing healthcare organizations to change clinical performance (2004) propose “the formation of evidence-based clinical practice support units in hospitals and clinical research implementation networks.” They realized that medical problems would not be solved only by the computerization although they did not propose any constructive examples. The author of the claimed system has the same opinion but also constructive solutions. The health care system of the universal and continuously enriching medical information introduces new clinical practices, like the introduction of the appointment charts by the Internet, the introduction of the different laboratories in the clinics where specimens are taken by physicians, introduction of billing system by the different health providers in order to make an efficient service and giving the personal health information to patients in order that they can prevent diseases and chose appropriate health providers. The medical information are efficiently summarized and focused in the universal clinical-laboratory forms in order to be anticipated future medical problems. The referring doctor makes appointments for the specific health providers in order to be avoided unnecessary waiting of sick people. The health providers continuously change system interacting with it by the Watchdog. The claimed system is based on these improvements that are combined with medical informatics.

The U.S. Pat. No. 6,684,188 is the method for production of medical records and other technical documents. This is accomplished by “generating an intelligent computer-guided interview and the use of serialized scriptable objects.” The physicians collect information according to their knowledge and experiences in the health care system of the universal and continuously enriching medical information. This is an essential difference.

The U.S. Pat. No. 6,638,218 (2003) claims “the system and method for delivering medical examination, diagnosis, and treatment services from a physician to a patient over network is provided. A physician call center enables any of a first plurality of physician terminals to be in audiovisual communication over the network with any of a second plurality of patient terminals. A call is received at the call center from a patient at one of the patient terminals and the call is routed to an available physician at one of the physician terminals. The available physician may carry on a two-way conversation with the patient, visually observe the patient, and make an assessment whether the patient may be suffering from an acute non-urgent condition. The available physician may conduct an examination of the patient over the network, including by visual study of the patient, only if the assessment is that the patient may be suffering from an acute non-urgent condition.”

The health care system of the universal and continuously enriching medical information also uses the Internet where the health providers share “essential information by the specific numbers that open the universal clinical-laboratory records given by the authorized physician and the personal patient medical records. This is essential difference.

The U.S. Pat. No. 6,725,200 (2004) concerns “a personal data archive system with portable personal storage devices allowing the owner to enter and store personal data. Authorization checking devices are allocated to the storage devices and grant access to at least some of the personal data stored in the storage devices only in the event of a positive authorization and/or authentication.” The health care system of the universal and continuously enriching medical information has the personal patient medical record instead of the portable personal storage device. The doctor and the patient add continuously medical information in it. The personal medical paper record belongs to the patient who brings it for the further medical investigation and for personal health education. Patients and their unauthorized health providers who do not belong to the system may use the personal patient medical records. They can also add their information in their paper medical records that will be put in the system only by the authorized physicians of the system.

What is claimed is:

1. A website based health care system running on a central server that is connected with the rest of the Internet comprises:
a. a health care organization of authorized health and different service providers working and cooperating according to the specific rules and methods;
b. the authorized physicians who have their patient and ordering files residing on the server;
c. the patient files that contain their name, address, sex, age, and health care number along with their universal clinical-laboratory records;
d. the identification numbers of the universal clinical-laboratory records that are composed of date and time of their submission;
e. the identification numbers of the ordering records that are composed of time and date of their submission;
f. the appointment charts inside the private workspace of the authorized health providers where they can make new appointments for their patients according to their available time and where the patients can also put their appointments according to their available time from the public pages of the website;
g. the specimen containers and the microbiological kits are in the offices of authorized physicians;
h. the microbiological kits that are designed according to the specimens (the sputum kit, the bronchoscope kit, the urine kit, the CSF kit, the pus kit, the sexual transmitted diseases kit and the kits tailored according to the specific needs of physicians) having the specific media that support growth of the specific pathogen organisms;
i. the Watchdog statistical system, that is available to the authorized health care providers, analyzes present information of the universal clinical-laboratory and ordering record information in order to give general picture of the present health problems;
j. the patient paper records that are the physicians compile copies of the computer medical records with the questionnaires and their answers compiled by the patients.

2. The universal clinical-laboratory form of claim 1 enables organized collection of different data such as:
a. the patient record number, sex and age of the patient;
b. the summarized clinical diagnosis with their dates that are produced by the website program that takes them from the previous universal clinical-laboratory records;
c. the summarized laboratory results with their dates that are also produced by the website program that takes them from the previous universal clinical-laboratory records;
d. the summarized patient data that are taken by the authorized physician from the patient health paper record;
e. the clinical findings and clinical diagnosis that are in advance given by the website program but chosen by the authorized physician who examined the patient;
f. the recommended treatments that are proscribed by the authorized physician who examined the patient, the price of drugs and the ID number of the pharmacist who will provide drugs;
g. the referrals to the authorized health providers or the authorized hospitals;
h. the different data of taken specimens that are put in the specific containers and inoculated in the media of the specific microbiological kits (claim 1, i) and this data are arranged in the tables that are combined with prices of their transporting to the authorized laboratories and the ID number of the authorized transport provider;
i. the questionnaire for the specific patient problems that will be answered by the patient;
j. the service price of the physician with his or her ID number;
k. the identification number of the universal clinical-laboratory form that is produced by the website program when the form is submitted by the authorized physician (claim 1) and it has in itself date and time of the submission;
l. the extension forms that have the specially designed microbiological and the other laboratory forms and empty fields for the other clinical examinations and all the above forms are connected with the fields for prices for the above services and the ID numbers of the health providers who provide the service;
m. the submitted information of the universal clinical-laboratory forms that cannot be changed.

3. The authorized physicians who order the new kits and containers, the kit and the container producers who produce them and the authorized transport providers who transport them use the ordering forms and their records that comprise:
a. the data of the newly ordered kits and containers with their prices of production and transporting that are connected with the ID numbers of their producers and transport providers and the locations where they are ordered;
b. the identification numbers of the ordering records are produced by the website when the physicians submit the ordering forms (claim 1);
c. the information of the specific ordering records is connected with the specific information of the used containers and kits of the universal clinical-laboratory forms;
d. the submitted information that cannot be changed.

4. The data of the containers and the kits with the specimens from the universal clinical-laboratory records (claim 2), including the fields for prices of their transporting to the authorized laboratories and the ID numbers of the authorized transport providers are transferred to the specific ordering records (claim 3) by the website program and the information of the price of the transporting and the ID of the transport provider are returned into the same universal clinical-laboratory records after the transport services also by the website program.

5. The transport media for different microbiological specimens do not exist because they are replaced with the kits that also have functions of the transport media and for growth of different pathogen organisms (bacteria, viruses, fungi and yeasts).

6. When the primary care physicians or the specialists submit the universal clinical-laboratory forms according to the claim 1, the records get the identification numbers by the system.

7. The authorized physicians who submitted the universal clinical-laboratory forms take the specimens from patients and put them in the containers or inoculate them in the plates and the tubes of the microbiological kits and write on them the numbers of the submitted universal clinical-laboratory records.

8. The authorized physician refers the patient with the number of his/her submitted universal clinical-laboratory record to the health providers in the specific appointment time that is also arranged by the referring physician (claim 1).

9. The authorized producers and transport providers of the kits open the ordering records to get the specific information of:
a. the new kits and containers requested for production;
b. the used kits and containers for their transport.

10. When the kit and producers give the specific kits and containers for the specific locations to the transport providers than they input information of their prices together with their IDs and IDs of the transport providers in the ordering records and submit them into the system.

11. When the transport providers give the new kits and containers to the physicians and/or give the used kits and containers to the authorized laboratories than they input information of spent time and kilometers together with prices of the transporting and their IDs in the ordering records and submit.

12. When the specimens and kits with the numbers come in the authorized laboratory or when the patients come in the health institution with the numbers (claim 7), than the authorized laboratory workers or the authorized health providers open their specific universal clinical-laboratory records by the above numbers where they can find the information on what should be done.

13. The authorized laboratory workers or the authorized health providers input their results with dates, prices of their service and their ID numbers in the designated place of the universal clinical-laboratory records and submit.

14. The referring physicians (primary care physicians, hospital physicians and specialists) open the enriched universal clinical-laboratory records, by their previously submitted numbers, that are in their patient computer files (claim 1).

15. When the same above physicians open the new universal clinical-laboratory forms to start new cycles of the examination, if it is necessary, than the information of the previous universal clinical-laboratory records is finished.

16. When the services (cycles) are finished, the authorized physicians make the personal paper copies of the universal clinical-laboratory records so that the patient can take preventive measures, transfer this information to another health system and pay the bill or bill their insurances.

17. The personal paper record have at their ends the special designated places with questions concerning the patients food habits, living, working and environmental conditions and they are expected to be fulfilled by the patients who will bring them to their physicians for the new examinations who will integrate them in their clinical histories.

18. The system has the program that continuously analyzes all present information of the universal clinical-laboratory and ordering records in order to provide the Watchdog with a general picture of the present diseases, their locations, pathogen organisms involved with their sensitivities patterns if they are bacteria, commonly proscribed treatments, billing information and other information related to present medical problems that are used by authorized users of the system.

19. The system enables that the authorized users interact with each other on the present information of the Watchdog, inside the Watchdog, in order to improve the service and the system that does not use any information which are products of other outside system inventions in order to keep simplicity of the system and to focus on its internal problems.

20. The identification numbers of the universal clinical-laboratory and the ordering records including ID numbers of the health providers are used for the grouping of the above records according to the dates inside the patient files, the involved health provider records and their institution record by the website program and this information is used for the specific statistical and the other needs of the health providers:
a. the specific information of the complete universal records of the patients as the clinical diagnosis with their dates and recommended treatments, the patient's FBC with differential blood cell analysis with their dates, the patient's electrolytes with their dates are summarized in their new clinical-laboratory forms (claim 2);
b. the specific information of the complete universal clinical-laboratory and ordering records of the health providers as the clinical diagnosis with their dates and recommended treatments, their specific services with their prices, the ordered kits with their prices are summarized and analyzed for their specific needs;
c. the specific information of the complete universal clinical-laboratory and ordering records of the institution as the clinical diagnosis with their dates and recommended treatments, their specific services with their prices, the ordered kits with their prices are summarized and analyzed for the specific needs of the institution.

21. The health providers who provide the service, input prices of their services and their ID numbers in the designated places of the universal clinical-laboratory and ordering forms in order that the system can continuously calculate how much they earned and how much patients or their insurance must pay to the system and for the statistical needs of the Watchdog.
